(19) United States
(12) Patent Application Publication
(10) Pub. No.: US 2007/0014704 A1
(43) Pub. Date: Jan. 18, 2007

(54) Fluidized-bed gasification furnace

(76) Inventors: Hiroshi Hashimoto, Tokyo (JP); Yuki Toyoda, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/485,375

(22) Filed: Jul. 13, 2006

Related U.S. Application Data
(60) Provisional application No. 60/698,930, filed on Jul. 14, 2005.

(51) Int. Cl. F27B 15/00

(52) U.S. Cl. 422/139

(57) ABSTRACT

A fluidized-bed gasification furnace has a gasification chamber for fluidizing a fluidized medium therein and pyrolyzing a material in the fluidized medium to produce a pyrolysis gas and a pyrolysis residue. The fluidized-bed gasification furnace also has a combustion chamber having a combustion portion for fluidizing a fluidized medium therein and combusting the pyrolysis residue to heat the fluidized medium and a settling portion disposed adjacent to the combustion portion and the gasification chamber for settling the heated fluidized medium therein. The fluidized-bed gasification furnace includes a first passage for introducing the pyrolysis residue from the gasification chamber to the combustion chamber together with the fluidized medium, a second passage for introducing the heated fluidized medium in the combustion chamber from the settling portion of the combustion chamber to the gasification chamber, and a first diffusion device for supplying a fluidizing gas to a first region in the combustion portion adjacent to the settling portion of the combustion chamber to move the fluidized medium from the combustion portion to the settling portion. The fluidized-bed gasification furnace also includes a circulation controller operable to adjust a flow rate of the fluidizing gas supplied from the first diffusion device to control a circulation amount of the fluidized medium.

### CROSS-REFERENCE TO RELATED APPLICATIONS

This application claims the benefit of priority of U.S. provisional application 60/698,930, filed Jul. 14, 2005.

### BACKGROUND OF THE INVENTION

1. Field of the Invention

The present invention relates to a fluidized-bed gasification furnace, and more particularly to a fluidized-bed gasification furnace suitable for generating a gas from a material such as various wastes and solid fuel. Further, the present invention also relates to a method of pyrolyzing and gasifying a material with such a fluidized-bed gasification furnace.

2. Description of the Related Art

There has heretofore been known a fluidized-bed gasification furnace for pyrolyzing various wastes or solid fuel such as coal to generate a product gas. In such a fluidized-bed gasification furnace, for example, the amount of oxygen or air to be supplied to the gasification furnace, which is one of various factors relating to reaction, is varied to change a temperature of a fluidized bed in the gasification furnace.

However, if the amount of oxygen to be supplied to the gasification furnace is increased, the amount of combustion gas contained in the product gas is increased so as to lower a calorific value of the product gas. Further, if the amount of oxygen to be supplied to the gasification furnace is reduced, the amount of generated pyrolysis residue such as char or tar is increased so as to lower an efficiency of gasification.

Accordingly, there has recently been developed an integrated fluidized-bed gasification furnace having a gasification chamber for pyrolyzing and gasifying a material such as wastes or solid fuel and a combustion chamber for combusting a pyrolysis residue such as char and tar generated by the gasification. In the integrated fluidized-bed gasification furnace, the combustion heat of a pyrolysis residue generated in the combustion chamber is utilized for heat of reaction of the gasification in the gasification chamber. Further, each of the gasification chamber and the combustion chamber in the integrated fluidized-bed gasification furnace has a fluidized bed formed by a fluidized medium. The fluidized medium is circulated between the gasification chamber and the combustion chamber to transfer a pyrolysis residue and heat between the gasification chamber and the combustion chamber.

In such an integrated fluidized-bed gasification furnace, it is important to accurately control the amount of fluidized medium to be circulated in order to smoothly transfer a pyrolysis residue from the gasification chamber to the combustion chamber or smoothly transfer heat from the combustion chamber to the gasification chamber.

### SUMMARY OF THE INVENTION

The present invention has been made in view of the above drawbacks. It is, therefore, an object of the present invention to provide a fluidized-bed gasification furnace and a pyrolysis and gasification method which can readily control a circulation amount of fluidized medium with accuracy and can stably transfer a pyrolysis residue and heat between a gasification chamber and a combustion chamber with ease.

According to a first aspect of the present invention, there is provided a fluidized-bed gasification furnace which can readily control a circulation amount of fluidized medium with accuracy and can stably transfer a pyrolysis residue and heat between a gasification chamber and a combustion chamber with ease. The fluidized-bed gasification furnace has a gasification chamber for fluidizing a fluidized medium therein and pyrolyzing a material in the fluidized medium to produce a pyrolysis gas and a pyrolysis residue. The fluidized-bed gasification furnace also has a combustion chamber having a combustion portion for fluidizing a fluidized medium therein and combusting the pyrolysis residue to heat the fluidized medium and a settling portion disposed adjacent to the combustion portion and the gasification chamber for moving the heated fluidized medium downward therein. The fluidized-bed gasification furnace includes a first passage for introducing the pyrolysis residue from the gasification chamber to the combustion chamber together with the fluidized medium, a second passage for introducing the heated fluidized medium from the settling portion of the combustion chamber to the gasification chamber, and a first diffusion device for supplying a fluidizing gas to a first region in the combustion portion adjacent to the settling portion of the combustion chamber to move the fluidized medium from the combustion portion to the settling portion. The fluidized-bed gasification furnace also includes a circulation controller operable to adjust a flow rate of the fluidizing gas supplied from the first diffusion device to control a circulation amount of the fluidized medium.

The fluidized-bed gasification furnace may further have a second diffusion device for supplying a fluidizing gas to a second region in the combustion portion away from the settling portion of the combustion chamber. In this case, the fluidized-bed gasification furnace may further have a combustion controller operable to adjust a flow rate of the fluidizing gas supplied from the second diffusion device to control combustion of the pyrolysis residue in the combustion chamber.

According to a second aspect of the present invention, there is provided a pyrolysis and gasification method which can readily control a circulation amount of fluidized medium with accuracy and can stably transfer a pyrolysis residue and heat between a gasification chamber and a combustion chamber with ease. In this method, a fluidized medium is fluidized in a gasification chamber. A material is pyrolyzed in the fluidized medium of the gasification chamber to produce a pyrolysis gas and a pyrolysis residue. The pyrolysis residue is introduced from the gasification chamber to a combustion portion of a combustion chamber together with the fluidized medium. A fluidized medium is fluidized in the combustion portion of the combustion chamber. The pyrolysis residue is combusted to heat the fluidized medium of the combustion chamber. A fluidizing gas is supplied to a first region of the combustion portion to move the fluidized medium from the combustion portion to a settling portion adjacent to the first region. The fluidized medium is moved downward in the settling portion. The fluidized medium is introduced from the settling portion to the gasification chamber. A flow rate of the fluidizing gas supplied to the first region of the combustion portion is adjusted to control a circulation amount of the fluidized medium.

Further, a fluidizing gas may be supplied to a second region in the combustion portion away from the settling portion of the combustion chamber independently of the first region of the combustion portion. In this case, it is desirable that a flow rate of the fluidizing gas supplied to the second region is adjusted to control combustion of the pyrolysis residue in the combustion chamber.

The above and other objects, features, and advantages of the present invention will be apparent from the following description when taken in conjunction with the accompanying drawings which illustrate preferred embodiments of the present invention by way of example.

### BRIEF DESCRIPTION OF THE DRAWINGS

FIG. 1 is a perspective view showing a fluidized-bed gasification furnace according to an embodiment of the present invention,

FIG. 2 is a plan view showing the fluidized-bed gasification furnace shown in FIG. 1; and

FIG. 3 is a schematic development showing an arrangement of chambers in the fluidized-bed gasification furnace shown in FIG. 1.

### DETAILED DESCRIPTION OF THE PREFERRED EMBODIMENTS

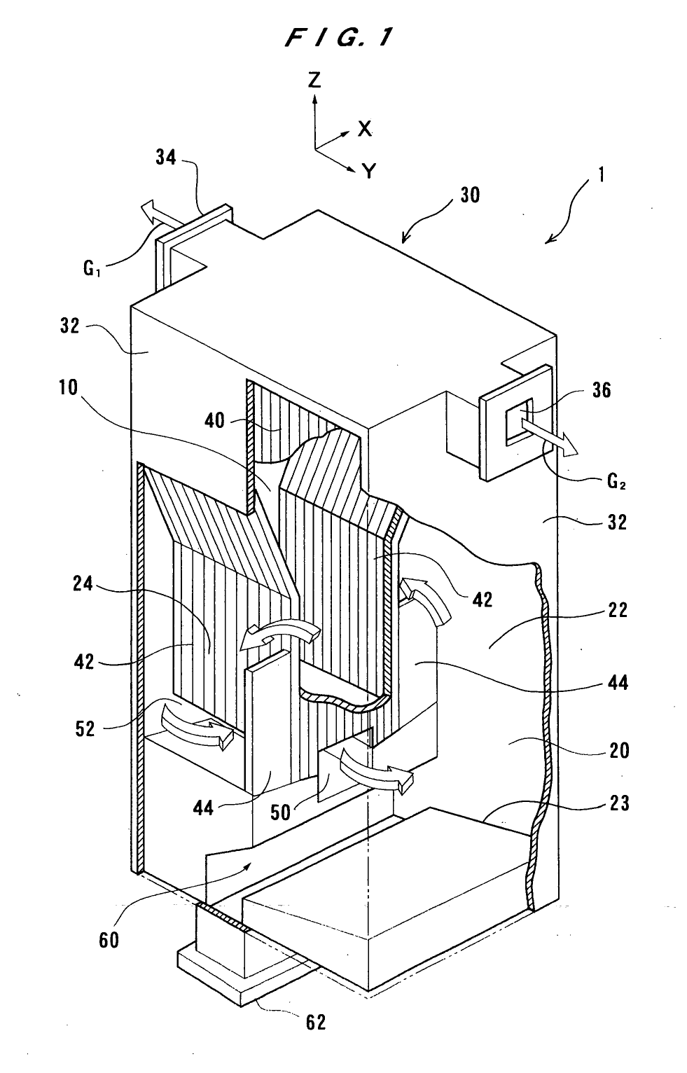

A fluidized-bed gasification furnace according to an embodiment of the present invention will be described below with reference to FIGS. 1, 2, and 3. Like or corresponding parts are denoted by like or corresponding reference numerals throughout drawings, and will not be described below repetitively.

FIG. 1 is a perspective view showing a fluidized-bed gasification furnace 1 according to an embodiment of the present invention. In FIG. 1, the fluidized-bed gasification furnace 1 is illustrated as being partially cut away so as to show an internal structure of the fluidized-bed gasification furnace 1. In a rectangular coordinate system XYZ, a horizontal plane is represented by XY, and a vertical axis is represented by Z. An axis Y is directed to a front of the fluidized-bed gasification furnace 1. The fluidized-bed gasification furnace 1 is configured so as to be symmetrical with respect to the axis Y. As shown in FIG. 1, the fluidized-bed gasification furnace 1 is formed as an integrated gasification furnace having a gasification chamber 10 for pyrolyzing and gasifying a material such as various wastes or solid fuel and a combustion chamber 20 for combusting a pyrolysis residue such as char and tar produced by the gasification to heat the fluidized medium.

As shown in FIG. 1, the fluidized-bed gasification furnace 1 has a furnace body 30 in the form of a rectangular parallelepiped. The gasification chamber 10 and the combustion chamber 20 are housed in the furnace body 30. Specifically, the fluidized-bed gasification furnace 1 includes a furnace body 30 having side surfaces formed of substantially rectangular furnace walls 32. Since the furnace body 30 is in the form of a rectangular parallelepiped, a degree of freedom of designing the fluidized-bed gasification furnace 1 is increased. For example, even if the length of the combustion chamber 20 is varied in a direction of the axis X or Y while the size of the gasification chamber 10 (area and shape of the gasification chamber 10) is fixed, it is possible to change only the size of the combustion chamber 20 into a desired value. Therefore, the fluidized-bed gasification furnace 1 can be designed so as to have an optimal size according to properties of a material (e.g., a ratio of fixed carbon). For example, in a case where the furnace body has a cylindrical shape, when one of the gasification chamber 10 and the combustion chamber 20 is varied in size, the other is also inevitably varied in size.

Each of the gasification chamber 10 and the combustion chamber 20 has a fluidized bed formed on a bottom of the chamber by a fluidized medium. The fluidized medium is fluidized by a fluidizing gas ejected from a diffusion device, which will be described later, so as to form the fluidized bed. The fluidized bed includes a dense bed located at a lower portion of the chamber in a vertical direction and a splash zone located above the dense bed in the vertical direction. The dense bed densely contains a fluidized medium (e.g., silica sand), which is fluidized by the fluidizing gas. The splash zone contains the fluidized medium and a large amount of gas. The fluidized medium is vigorously splashed in the splash zone. A freeboard is located above the fluidized bed, i.e., above the splash zone. The freeboard hardly contains the fluidized medium but mainly contains a gas. An interface of the fluidized bed includes the splash zone having a certain thickness. The interface of the fluidized bed may be regarded as an imaginary plane located at an intermediate location between an upper surface of the splash zone and a lower surface of the splash zone (an upper surface of the dense bed).

The gasification chamber 10 and the combustion chamber 20 are partitioned by a front partition wall 40 and side partition walls 42. The partition wall 40 extends from a furnace bottom to a ceiling of the gasification chamber 10. Each of the partition walls 42 extends from the vicinity of the furnace bottom in a vertical direction and curves obliquely in an upward direction at the freeboard so as to be connected to the furnace wall 32.

The combustion chamber 20 has partition walls 44 provided on both sides of the gasification chamber 10. Each of the partition walls 44 extends upward from the furnace bottom. Each of the partition walls 44 has an upper end located near the interface of the fluidized bed. Specifically, the upper end of the partition walls 44 is located above the upper surface of the dense bed but below the upper surface of the splash zone. The partition walls 44 define a char combustion portion 22 and two settling portions 24 in the combustion chamber 20. The char combustion portion 22 serves to combust a pyrolysis residue such as char and tar produced by gasification in the gasification chamber 10 so as to heat the fluidized medium. Further, the settling portions 24 serve to downwardly move the fluidized medium heated in the char combustion portion 22 and supply it to the gasification chamber 10.

As shown in FIG. 1, the gasification chamber 10 has a product gas discharge port 34 provided on an upper portion thereof for discharging a product gas G₁ produced in the gasification chamber 10. The combustion chamber 20 has a combustion gas discharge port 36 provided on an upper portion thereof for discharging a combustion gas G₂ produced in the combustion chamber 20. The gasification chamber 10 has a space widened at the freeboard located below the product gas discharge port 34. Accordingly, the superficial velocity of the product gas G₁ can be reduced before the product gas G₁ is discharged from the product gas discharge port 34. Therefore, it is possible to prevent unburnt components from scattering and maintain a reaction time (residence time) sufficiently long enough to pyrolyze the product gas G₁.

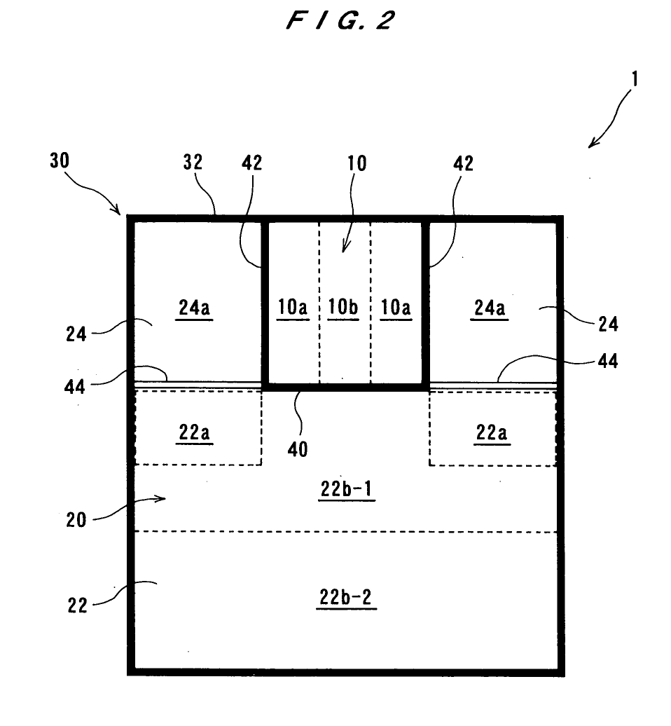

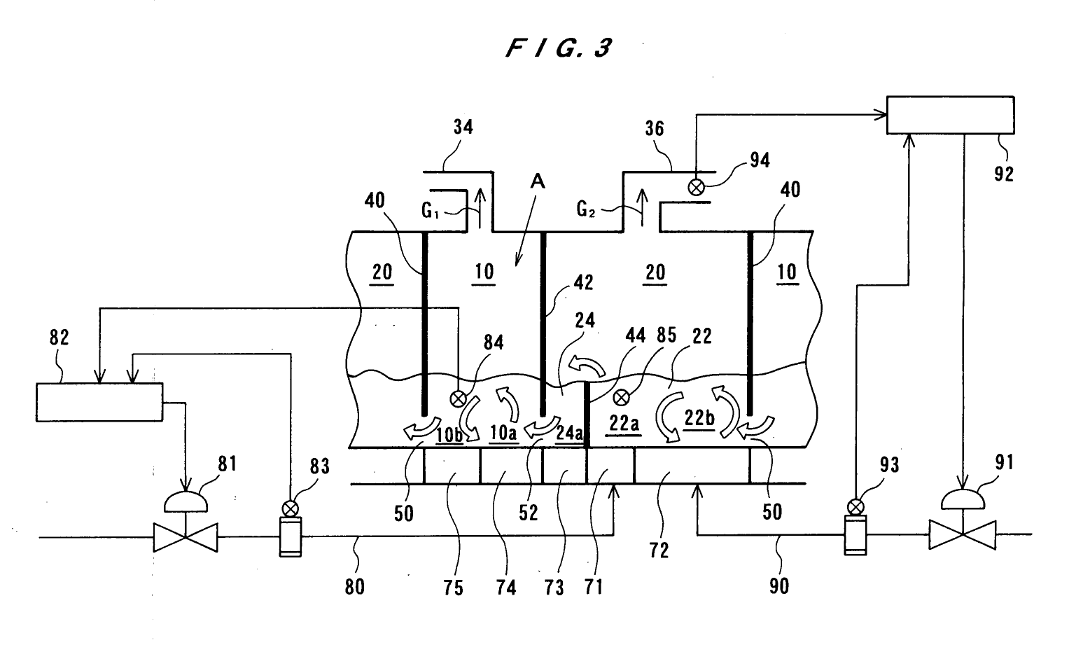

FIG. 2 is a plan view of the fluidized-bed gasification furnace 1, and FIG. 3 is a development schematically showing an arrangement of the chambers in the fluidized-bed gasification furnace 1. As shown in FIGS. 1 and 3, the partition wall 40 contiguous to the char combustion portion 22 has an opening 50 defined at a lower portion thereof. The opening 50 connects the gasification chamber 10 and the char combustion portion 22 of the combustion chamber 20 to each other. Each of the partition walls 42 contiguous to the settling portions 24 has an openings 52 defined at a lower portion thereof. The openings 52 connect the gasification chamber 10 and the settling portions 24 to each other.

The opening 50 defined in the partition wall 40 serves as a passage a fluidized medium from the gasification chamber 10 to the char combustion portion 22 of the combustion chamber 20. The openings 52 defined in the partition walls 42 serve as passages for introducing a fluidized medium from the settling portions 24 of the combustion chamber 20 to the gasification chamber 10. The opening 50 of the partition wall 40 is designed so as to be always located below an upper surface of the fluidized bed in the gasification chamber 10 and an upper surface of the fluidized bed in the char combustion portion 22 of the combustion chamber 20 during operation of the fluidized-bed gasification furnace 1. The openings 52 of the partition walls 42 are designed so as to be always located below an upper surface of the fluidized bed in the gasification chamber 10 and upper surfaces of the fluidized beds in the settling portions 24 during operation of the fluidized-bed gasification furnace 1. Preferably, the opening 50 of the partition wall 40 has an upper end located below an upper surface of a dense bed of the fluidized bed in the gasification chamber 10 and an upper surface of a dense bed of the fluidized bed in the char combustion portion 22. Preferably, each of the openings 52 of the partition walls 42 has an upper end located below an upper surface of a dense bed of the fluidized bed in the gasification chamber 10 and an upper surface of a dense bed of the fluidized bed in the settling portion 24. Accordingly, a valuable product gas G₁ produced in the gasification chamber 10 and a combustion gas G₂ produced in the combustion chamber 20 hardly pass through the openings 52 and the opening 50.

As shown in FIG. 1, an incombustible withdrawing port 60 is formed below the opening 50 of the partition wall 40. The incombustible withdrawing port 60 is connected to an incombustible discharge port 62 for discharging incombustibles to the exterior of the furnace. Thus, in the present embodiment, incombustibles are discharged from the furnace bottom of the char combustion chamber 20. Further, the char combustion portion 22 of the combustion chamber 20 has a furnace bottom 23 inclined toward the incombustible withdrawing port 60 to facilitate discharge of the incombustibles.

As shown in FIG. 3, the fluidized-bed gasification furnace includes first diffusion devices 71 and a second diffusion device 72 provided on the furnace bottom of the char combustion portion 22 in the combustion chamber 20. The first diffusion devices 71 are configured to eject a fluidizing gas to regions 22a near the settling portions 24. The second diffusion device 72 is configured to eject a fluidizing gas to a region 22b away from the settling portions 24. Further, the fluidized-bed gasification furnace includes third diffusion devices 73 provided on the furnace bottoms of the settling portions 24 in the combustion chamber 20. The third diffusion devices 73 are configured to eject a fluidizing gas to regions 24a in the settling portions 24. Furthermore, the fluidized-bed gasification furnace includes fourth diffusion devices 74 and a fifth diffusion device 75 provided on the furnace bottom of the gasification chamber 10. The fourth diffusion devices 74 are configured to eject a fluidizing gas to regions 10a near the partition walls 42. The fifth diffusion device 75 is configured to eject a fluidizing gas to a region 10b away from the partition walls 42.

The first diffusion devices 71 are connected to a gas line 80, which supplies air or steam as a fluidizing gas to the first diffusion devices 71. The gas line 80 has a flow regulating valve 81 provided thereon. The flow regulating valve 81 is connected to a circulation controller 82 operable to control the amount of circulation of the fluidized medium. Thus, the flow rate of the fluidizing gas to be supplied to the first diffusion devices 71 is adjusted by the circulation controller 82. Further, in the present embodiment, the gas line 80 has a flowmeter 83 for detecting the flow rate of the fluidizing gas to be supplied to the first diffusion devices 71. An output of the flowmeter 83 is inputted to the circulation controller 82.

The second diffusion device 72 is connected to a gas line 90, which supplies air as a fluidizing gas to the second diffusion device 72. The gas line 90 has a flow regulating valve 91 provided thereon. The flow regulating valve 91 is connected to a combustion controller 92 operable to control combustion of char in the combustion chamber 20. Thus, the flow rate of the fluidizing gas to be supplied to the second diffusion device 72 is adjusted by the combustion controller 92. Further, in the present embodiment, the gas line 90 has a flowmeter 93 for detecting the flow rate of the fluidizing gas to be supplied to the second diffusion device 72. An output of the flowmeter 93 is inputted to the combustion controller 92.

Similarly, the third diffusion devices 73, the fourth diffusion devices 74, and the fifth diffusion device 75 are connected to gas lines for supplying a fluidizing gas, which are not illustrated in the drawings.

Each of the diffusion devices 71, 72, 73, 74, and 75 has a porous plate disposed on the furnace bottom and a plurality of chambers divided in a width direction. Each diffusion device is operable to adjust a fluidization state at a local area by varying a flow rate of a fluidizing gas ejected from the chambers through the porous plate.

In the present embodiment, the first diffusion devices 71 are configured to form intense fluidizing areas at the regions 22a. The second diffusion device 72 is configured to form an intense fluidizing area at a region 22b-1 (see FIG. 2) near the partition wall 40 and form a weak fluidizing area at a region 22b-2 (see FIG. 2) away from the partition wall 40. Further, the third diffusion devices 73 are configured to form weak fluidizing areas at the regions 24a in the settling portions 24. The fourth diffusion devices 74 are configured to form intense fluidizing areas at the regions 10a near the partition walls 42. The fifth diffusion device 75 is configured to form a weak fluidizing area at the region 10b away from the partition walls 42. Thus, since fluidization states are different from region to region in the chambers, it is possible to form an internal circulating flow in the gasification chamber 10 and the combustion chamber 20 and circulate the fluidized medium between the gasification chamber 10 and the char combustion portion 22.

It is desirable that the intense fluidizing areas in the gasification chamber 10 and the combustion chamber 20 have a fluidizing velocity of at least 5 Umf, and that the weak fluidizing areas in the gasification chamber 10 and the combustion chamber 20 have a fluidizing velocity of at most 5 Umf. The weak fluidizing areas and the intense fluidizing areas may have any flow velocity as long as fluidizing velocities of the weak fluidizing areas and the intense fluidizing areas are clearly different from each other. The unit Umf is defined such that 1 Umf is equal to a minimum fluidizing velocity (a velocity at which fluidization is started). Specifically, 5 Umf is 5 times as high as a minimum fluidizing velocity.

As shown in FIG. 3, the gasification chamber 10 in the present embodiment has a temperature sensor 84 for detecting a temperature of the fluidized medium in the gasification chamber 10. An output of the temperature sensor 84 is inputted to the circulation controller 82. For example, the temperature sensor 84 is disposed upstream of the opening 50 defined in the partition wall 40. The temperature sensor 84 may directly detect a temperature of the fluidized medium or indirectly detect a temperature of the fluidized medium. Further, the combustion chamber 20 has a temperature sensor 85 for detecting a temperature of the fluidized medium in the combustion chamber 20. An output of the temperature sensor 85 is inputted to the circulation controller 82. The temperature sensor 85 may directly detect a temperature of the fluidized medium or indirectly detect a temperature of the fluidized medium. Further, an oxygen concentration sensor 94 is provided in the combustion gas discharge port 36 of the combustion chamber 20 for detecting an oxygen concentration of the combustion gas G₂ discharged from the combustion chamber 20. An output of oxygen concentration sensor 94 is inputted to the combustion controller 92.

Material A such as wastes or solid fuel is introduced through a material supply port (not shown) into the gasification chamber 10. The material A is pyrolyzed and gasified by heat received from the fluidized medium in the gasification chamber 10. Specifically, the material A is pyrolyzed into combustible gas, char, and ash content. Typically, the material A is not combusted in the gasification chamber 10 but is carbonized. It is desirable that the material A to be supplied into the gasification chamber 10 includes organic wastes or fuel having a high calorific value, such as waste plastics, tire wastes, automobile shredder dust, ligneous wastes, municipal solid wastes, RDF, coal, heavy oil, or tar.

As described above, the intense fluidizing areas are formed at the regions 10a in the gasification chamber 10, and the weak fluidizing area is formed at the region 10b in the gasification chamber 10. Thus, fluidization states are different between the regions 10a and the region 10b. Accordingly, it is possible to form an internal circulating flow of the fluidized medium in the gasification chamber 10.

The weak fluidizing area is formed at the region 10b in the gasification chamber 10, and the intense fluidizing area is formed at the region 22b-1 in the combustion chamber 20. The region 22b-1 in the combustion chamber 20 is maintained at a stronger fluidization state than the region 10b in the gasification chamber 10. Accordingly, a pressure difference is produced between adjacent regions interposing the partition wall 40 therebetween. Char is produced by pyrolysis in the gasification chamber 10. Char having such a large particle diameter that it is not involved in the combustible gas flows through the lower opening 50 of the partition wall 40 into the combustion chamber 20 together with the fluidized medium in the gasification chamber 10.

The char is completely combusted in the combustion chamber 20 by using a fluidizing gas of air or an oxygen gas such as oxygen-rich air or oxygen. Heat produced by combustion of the char heats the fluidized medium in the combustion chamber 20. The intense fluidizing area is formed at the region 22b-1 in the combustion chamber 20, and the weak fluidizing area is formed at the region 22b-2 in the combustion chamber 20. Thus, fluidization states are different between the region 22b-1 and the region 22b-2. Accordingly, an internal circulating flow of the fluidized medium is formed in the combustion chamber 20. The fluidized medium is circulated and sufficiently heated by the internal circulating flow.

The intense fluidizing areas are formed at the regions 22a near the partition walls 44 in the char combustion portion 22. The fluidized medium at the regions 22a of the char combustion portion 22 flows over upper ends of the partition walls 44 into the settling portions 24. The weak fluidizing areas are formed at the regions 24a in the settling portions 24, and the intense fluidizing areas are formed at the regions 10a near the partition walls 42 in the gasification chamber 10. The regions 10a in the gasification chamber 10 are maintained at a stronger fluidization state than the regions 24a in the settling portions 24. Accordingly, a pressure difference is produced between adjacent regions interposing the partition walls 42 therebetween. The fluidized medium in the settling portions 24 flows through the openings 52 of the partition walls 42 into the gasification chamber 10. Thus, the fluidized medium that has flowed from the regions 22a in the char combustion portion 22 into the settling portions 24 moves downward (toward the furnace bottom) in the settling portions 24 and then flows through the openings 52 of the partition walls 42 into the gasification chamber 10.

In the above manner, the fluidized medium is circulated between the gasification chamber 10 and the combustion chamber 20 so as to transfer a pyrolysis residue and heat between the gasification chamber 10 and the combustion chamber 20.

As described above, it is important to control the circulation amount of fluidized medium in order to smoothly transfer a pyrolysis residue from the gasification chamber 10 to the combustion chamber 20 and smoothly transfer heat from the combustion chamber 20 to the gasification chamber 10 in the integrated fluidized-bed gasification furnace. The inventors have found that the circulation amount of fluidized medium can readily be controlled with accuracy by adjusting a Umf ratio at the regions 22a adjacent to the settling portions 24.

Specifically, when a Umf ratio of a fluidizing gas supplied to the regions 22a adjacent to the settling portions 24 is increased, the amount of fluidized medium flowing over the partition walls 44 into the settling portions 24 is increased. However, if the amount of fluidized medium flowing into the settling portions 24 is increased, a large difference is produced between pressures at the regions 24a in the settling portions 24 and pressures at the regions 10a in the gasification chamber 10. Thus, it is possible to increase the amount of fluidized medium moving from the combustion chamber 20 to the gasification chamber 10, i.e., the amount of fluidized medium circulated in the fluidized-bed gasification furnace 1. Accordingly, the circulation amount of fluidized medium can readily be controlled with accuracy by adjusting a Umf ratio at the regions 22a adjacent to the settling portions 24.

In order to enhance an efficiency of gasification in the gasification chamber 10, the temperature of the fluidized medium should be maintained at a proper value in the gasification chamber 10. In the present embodiment, a Umf ratio of the fluidizing gas ejected from the first diffusion devices 71 is controlled to properly adjust a Umf ratio at the regions 22a adjacent to the settling portions 24. Accordingly, the temperature of the fluidized medium is maintained at a proper value in the gasification chamber 10. A Umf ratio varies according to the temperature of the fluidized medium. The temperature of the fluidized medium in the combustion chamber 20 is detected by the temperature sensor 85. The circulation controller 82 is operable to calculate a Umf ratio of the fluidizing gas ejected from the first diffusion devices 71 based on a flow rate of the fluidizing gas that is detected by the flowmeter 83 and a temperature of the fluidized medium in the combustion chamber 20 that is detected by the temperature sensor 85. Further, the circulation controller 82 is operable to adjust an opening of the flow regulating valve 81 based on the calculated Umf ratio so that a temperature of the fluidized medium in the gasification chamber 10 that is detected by the temperature sensor 84 is maintained at a desired value. Thus, a flow rate of the fluidizing gas ejected from the first diffusion devices 71 is adjusted.

The circulation controller 82 may perform the above control based on representative temperatures that are measured at one point in each of the gasification chamber 10 and the combustion chamber 20. Alternatively, the circulation controller 82 may perform the above control based on averages of temperatures that are measured at a plurality of points in each of the gasification chamber 10 and the combustion chamber 20. The calculation of a Umf ratio is preferably performed based on a temperature measured at the regions 22a in the combustion chamber 20. Alternatively, a flow rate of the fluidizing gas may be adjusted based on a difference between a temperature of the fluidized medium in the gasification chamber 10 and a temperature of the fluidized medium in the combustion chamber 20.

When an air ratio is high in the fluidized bed of the combustion chamber 20, a combustion rate of char is improved so as to transfer combustion heat of the char efficiently to the fluidized medium. If an air ratio is excessively increased in the fluidized bed of the combustion chamber 20, the amount of heat dissipated as the combustion gas G₂ from the fluidized bed is increased. Accordingly, the temperature of the fluidized medium is decreased. Preferably, an air ratio is adjusted so as to be in a rage of about 0.8 to about 1.2.

As described above, the circulation amount of fluidized medium can be adjusted at a desired value by the circulation controller 82. In a case where a flow rate of the fluidizing gas from the second diffusion device 72 is maintained at a constant value, an air ratio varies in the fluidized bed of the combustion chamber 20 if the amount of fluidizing gas (air) from the diffusion device 71 is changed by the circulation controller 82. Accordingly, the temperature of the fluidized medium in the combustion chamber 20 is varied. As a result, the temperature of the fluidized medium in the gasification chamber 10 is also varied. The amount and quality of the product gas G₁ are varied by the change in temperature of the fluidized medium in the gasification chamber 10. Further, the circulation amount of fluidized medium is required to be controlled by the circulation controller 82.

Therefore, in the present embodiment, an oxygen concentration of the combustion gas G₂ discharged from the combustion chamber 20 is detected by the oxygen concentration sensor 94. A flow rate of the fluidizing gas ejected from the second diffusion device 72 is adjusted based on the oxygen concentration of the combustion gas G₂ so as to control an air ratio in the fluidized bed of the combustion chamber 20 at a desired value. For example, when the oxygen concentration of the combustion gas G₂ is decreased, the combustion controller 92 increases an opening of the flow regulating valve 93 in order to increase a flow rate of the fluidizing gas ejected from the second diffusion device 72.

In the present embodiment, the flow rate of the fluidizing gas ejected from the second diffusion device 72 based on the oxygen concentration of the combustion gas G₂ discharged from the combustion chamber 20. However, for example, a flow rate of the fluidizing gas ejected from the second diffusion device 72 may be adjusted based on a ratio (oxygen ratio) of the amount of oxygen required for combustion of char and the amount of oxygen in the fluidizing gas from the second diffusion device 72. In this case, for example, the amount of char to be produced is calculated from the amount of the supplied material A. Then, the amount of oxygen required for combustion of char is calculated from the calculated amount of char to be produced. The amount of oxygen in the fluidizing gas is calculated from the flow rate of the fluidizing gas that is detected by the flowmeter 93. The flow rate of the fluidizing gas ejected from the second diffusion device 72 is adjusted based on the calculated amount of oxygen required for combustion of char and the calculated amount of oxygen in the fluidizing gas.

As described above, according to the present embodiment, the fluidized-bed gasification furnace 1 has the circulation controller 82 operable to adjust the flow rate of the fluidizing gas ejected from the first diffusion devices 71 so as to control the circulation amount of fluidized medium and the combustion controller 92 operable to adjust the flow rate of the fluidizing gas ejected from the second diffusion device 72 so as to control combustion of the pyrolysis residue in the combustion chamber 20. Therefore, it is possible to control the circulation amount of fluidized medium in the fluidized-bed gasification furnace 1 and the air ratio in the combustion chamber 20 independently of each other.

Although certain preferred embodiments of the present invention have been shown and described in detail, it should be understood that various changes and modifications may be made therein without departing from the scope of the appended claims.

What is claimed is:

1. A fluidized-bed gasification furnace comprising:
a gasification chamber for fluidizing a fluidized medium therein and pyrolyzing a material in the fluidized medium to produce a pyrolysis gas and a pyrolysis residue;
a combustion chamber having a combustion portion for fluidizing a fluidized medium therein and combusting the pyrolysis residue to heat the fluidized medium and a settling portion disposed adjacent to said combustion portion and said gasification chamber for moving the heated fluidized medium downward therein;
a first passage for introducing the pyrolysis residue from said gasification chamber to said combustion chamber together with the fluidized medium;
a second passage for introducing the heated fluidized medium from said settling portion of said combustion chamber to said gasification chamber;
a first diffusion device for supplying a fluidizing gas to a first region in said combustion portion adjacent to said settling portion of said combustion chamber to move the fluidized medium from said combustion portion to said settling portion; and
a circulation controller operable to adjust a flow rate of the fluidizing gas supplied from said first diffusion device to control a circulation amount of the fluidized medium.

2. The fluidized-bed gasification furnace as recited in claim 1, further comprising:
a first temperature sensor for detecting a temperature of the fluidized medium in said gasification chamber; and
a second temperature sensor for detecting a temperature of the fluidized medium in said combustion chamber,
wherein said circulation controller is operable to adjust the flow rate of the fluidizing gas supplied from said first diffusion device based on the temperature of the fluidized medium detected by said second temperature sensor so that the temperature of the fluidized medium detected by said first temperature sensor is maintained at a predetermined value.

3. The fluidized-bed gasification furnace as recited in claim 1, further comprising:
a first temperature sensor for detecting a temperature of the fluidized medium in said gasification chamber; and
a second temperature sensor for detecting a temperature of the fluidized medium in said combustion chamber,
wherein said circulation controller is operable to adjust the flow rate of the fluidizing gas supplied from said first diffusion device based on a difference between the temperature of the fluidized medium detected by said first temperature sensor and the temperature of the fluidized medium detected by said second temperature sensor so that the temperature of the fluidized medium detected by said first temperature sensor is maintained at a predetermined value.

4. The fluidized-bed gasification furnace as recited in claim 1, further comprising a second diffusion device for supplying a fluidizing gas to a second region in said combustion portion away from said settling portion of said combustion chamber.

5. The fluidized-bed gasification furnace as recited in claim 4, further comprising a combustion controller operable to adjust a flow rate of the fluidizing gas supplied from said second diffusion device to control combustion of the pyrolysis residue in said combustion chamber.

6. The fluidized-bed gasification furnace as recited in claim 5, further comprising an oxygen concentration sensor for detecting an oxygen concentration of a combustion gas discharged from said combustion chamber,
wherein said combustion controller is operable to adjust the flow rate of the fluidizing gas supplied from said second diffusion device based on the oxygen concentration detected by said oxygen concentration sensor.

7. The fluidized-bed gasification furnace as recited in claim 5, wherein said combustion controller is operable to adjust the flow rate of the fluidizing gas supplied from said second diffusion device based on a ratio of an amount of oxygen required for combustion of the pyrolysis residue and the amount of oxygen in the fluidizing gas supplied from said second diffusion device.

8. A pyrolysis and gasification method comprising:
fluidizing a fluidized medium in a gasification chamber;
pyrolyzing a material in the fluidized medium of said gasification chamber to produce a pyrolysis gas and a pyrolysis residue;
introducing the pyrolysis residue from said gasification chamber to a combustion portion of a combustion chamber together with the fluidized medium;
fluidizing a fluidized medium in said combustion portion of said combustion chamber;
combusting the pyrolysis residue to heat the fluidized medium of said combustion chamber;
supplying a fluidizing gas to a first region of said combustion portion to move the fluidized medium from said combustion portion to a settling portion adjacent to said first region;
moving the fluidized medium downward in said settling portion;
introducing the fluidized medium from said settling portion to said gasification chamber; and
adjusting a flow rate of the fluidizing gas supplied to said first region of said combustion portion to control a circulation amount of the fluidized medium.

9. The pyrolysis and gasification method as recited in claim 8, further comprising detecting a temperature of the fluidized medium in said gasification chamber and a temperature of the fluidized medium in said combustion chamber,
wherein said adjusting the flow rate of the fluidizing gas supplied to said first region of said combustion portion comprises adjusting the flow rate of the fluidizing gas supplied to said first region of said combustion portion based on the detected temperature of the fluidized medium in said combustion chamber so that the detected temperature of the fluidized medium in said gasification chamber is maintained at a predetermined value.

10. The pyrolysis and gasification method as recited in claim 8, further comprising detecting a temperature of the fluidized medium in said gasification chamber and a temperature of the fluidized medium in said combustion chamber,
wherein said adjusting the flow rate of the fluidizing gas supplied to said first region of said combustion portion comprises adjusting the flow rate of the fluidizing gas supplied to said first region of said combustion portion based on a difference between the detected temperature of the fluidized medium in said gasification chamber and the detected temperature of the fluidized medium in said combustion chamber so that the detected temperature of the fluidized medium in said gasification chamber is maintained at a predetermined value.

11. The pyrolysis and gasification method as recited in claim 8, further comprising supplying a fluidizing gas to a second region in said combustion portion away from said settling portion of said combustion chamber independently of said first region of said combustion portion.

12. The pyrolysis and gasification method as recited in claim 11, further comprising adjusting a flow rate of the fluidizing gas supplied to said second region to control combustion of the pyrolysis residue in said combustion chamber.

13. The pyrolysis and gasification method as recited in claim 12, further comprising detecting an oxygen concentration of a combustion gas discharged from said combustion chamber,
wherein said adjusting the flow rate of the fluidizing gas supplied to said second region comprises adjusting the flow rate of the fluidizing gas supplied to said second region based on the detected oxygen concentration.

14. The pyrolysis and gasification method as recited in claim 12, wherein said adjusting the flow rate of the fluidizing gas supplied to said second region comprises adjusting the flow rate of the fluidizing gas supplied to said second region based on a ratio of an amount of oxygen required for combustion of the pyrolysis residue in said combustion chamber and the amount of oxygen in the fluidizing gas supplied to said second region.
